(19) United States
(12) Patent Application Publication
(10) Pub. No.: US 2026/0072865 A1
(43) Pub. Date: Mar. 12, 2026

(54) TRANSCEIVER FOR A COMMANDER SUBSCRIBER STATION OR A RESPONDER SUBSCRIBER STATION OF A SERIAL BUS SYSTEM AND METHOD FOR COMMUNICATION IN A SERIAL BUS SYSTEM

(71) Applicant: Robert Bosch GmbH, Stuttgart (DE)

(72) Inventors: Arthur Mutter, Neuhausen (DE); Steffen Walker, Reutlingen (DE)

(21) Appl. No.: 19/294,435

(22) Filed: Aug. 8, 2025

(30) Foreign Application Priority Data
Sep. 10, 2024 (DE) 10 2024 208 570.7

(51) Int. Cl. G06F 13/42

(52) U.S. Cl. CPC G06F 13/4282; G06F 2213/0002

(57) ABSTRACT

A transceiver for a commander or responder subscriber station of a serial bus system. The transceiver includes a transmitter module for sending a digital transmission signal based on a frame for a message to be sent via the bus as a differential signal to a bus of the bus system, a receiver module for receiving a differential signal from the bus and for generating a digital reception signal from the differential signal received from the bus and for forwarding the digital reception signal to a communication control device for evaluating the digital reception signal using a predetermined frame for a message from the bus, and an operating mode switching module for switching the transmitter module and the receiver module into a first operating mode between messages on the bus or into a second or third operating mode for sending or receiving a message.

### CROSS REFERENCE

The present application claims the benefit under 35 U.S.C. § 119 of Germany Patent Application No. DE 10 2024 208 570.7 filed on Sep. 10, 2024, which is expressly incorporated herein by reference in its entirety.

### FIELD

The present invention relates to a transceiver for a commander subscriber station or a responder subscriber station of a serial bus system and a method for communication in a serial bus system.

### BACKGROUND INFORMATION

Bus systems are used in many areas of technology for communication between technical devices, such as sensors and control units.

The use of Classical CAN and/or CAN FD, which are both standardized in the international standard ISO 11898-1:2015, for communication between devices in vehicles and/or other technical equipment is well-known. CAN FD enables communication on the bus at speeds of 2 Mbit/s or 5 Mbit/s, for example. 64 bytes can be sent per message on the bus.

CAN XL, which is compatible with CAN FD and is specified in ISO/DIS 11898-1:2024 can also be used. CAN XL enables communication on the bus at bit rates up to 20 Mbit/s and with a data volume per message up to 2048 bytes.

The subscriber stations of such a bus system are also referred to as nodes. Such subscriber stations comprise a microcontroller that, in the case of CAN XL, supports all functions of the abovementioned standard for Classical CAN and/or CAN FD and/or CAN XL.

The major advantage of CAN XL is that data can be exchanged between subscriber stations of the bus system at significantly higher speeds than with Classical CAN or CAN FD. However, the demands placed on communication devices for the implementation of communication with CAN XL, and thus their costs, are higher than for communication devices that are designed only for Classical CAN and/or CAN FD.

The cost aspect is particularly disadvantageous for subscriber stations that only have to carry out very simple function(s). Examples of such subscriber stations include an indicator light, in particular a light-emitting diode (LED), that is to be switched on or off under the control of the microcontroller of another subscriber station and/or is required to change color as needed. Another example is a sensor that has to periodically provide its acquisition data to the microcontroller of another subscriber station.

There is therefore the desire to nonetheless utilize the advantages of CAN XL at lower communication costs than before. Due to the complexity of CAN XL, however, this is not easily possible.

### SUMMARY

An object of the present invention is to provide a transceiver for a commander subscriber station or a responder subscriber station of a serial bus system and a method for communication in a serial bus system that solve the aforementioned problems. In particular a transceiver for a commander subscriber station or a responder subscriber station of a serial bus system and a method for communication in a serial bus system are to be provided, in which communication in the serial bus system is possible with high error robustness and a higher bit rate than before, and also with a high net data transmission rate, but at lower cost than before.

The object may be achieved by a transceiver for a commander subscriber station or a responder subscriber station of a serial bus system having certain features of the present invention. According to an example embodiment of the present invention, the transceiver comprises a transmitter module for sending a digital transmission signal based on a frame for a message to be sent via the bus as a differential signal to a bus of the bus system, a receiver module for receiving a differential signal from the bus and for generating a digital reception signal from the differential signal received from the bus and for forwarding the digital reception signal to a communication control device for evaluating the digital reception signal using a predetermined frame for a message from the bus, and an operating mode switching module for switching the transmitter module and the receiver module into a first operating mode between messages on the bus or for switching the transmitter module and the receiver module into a second or third operating mode for sending or receiving a message, wherein the operating mode switching module is configured to switch the transmitter module and the receiver module from the first operating mode into the third operating mode for receiving a message from the bus when the operating mode switching module has received an edge from the bus.

The described transceiver for a subscriber station (commander or responder) of the present invention can be implemented as a CAN XL transceiver or a CAN SIC XL transceiver with significantly reduced functionality and/or significantly lower circuit design complexity. This is made possible by communication with CAN XL light, because the bus system no longer uses a dominant bus state, which requires significantly higher circuit complexity for control than the other bus states. The communication can also be referred to as extended CAN XL light or CAN XL light Extended.

The elimination of the dominant bus state also enables 100% symmetry of the impedance between the terminals for the bus signals. For a CAN bus system, the terminals CANH, CANL can be called CANH, CANL for the differential bus signals CAN_H, CAN_L. Since the dominant bus state forces asymmetry at the CAN_H, CAN_L terminals that reduces the transmittable bit rate and can increase electromagnetic emissions from the subscriber station, the design of the described subscriber station (responder) has a significant advantage in terms of signal quality. The elimination of the dominant bus state also results in a reduction of the semiconductor surface area, in particular silicon surface area, and sameness of the circuit on the bus terminals for the bus states L0 and L1. This provides advantages, both in terms of improved interference resistance of the subscriber station and reduced radiation from the subscriber station.

A very significant advantage of the described transceiver of the present invention for a commander subscriber station or a responder subscriber station is greatly reduced costs at the system level. One reason for the greatly reduced costs is that, at least in the responder subscriber station, a CAN XL transceiver or CAN SIC XL transceiver with significantly reduced functionality can be used. Another reason for the cost reduction is that there is no need for a high-precision clock in the responder subscriber station, because arbitration is not necessary for communication on the bus and is therefore not supported or carried out by the responder subscriber station. In arbitration, the identifier (ID) in an arbitration field is used to negotiate bit by bit between subscriber stations on the bus which subscriber station wants to send the message with the highest priority and therefore receive exclusive access to the bus of the bus system 1 for the next transmission time in the subsequent data phase, as is the case in the CAN bus system from ISO/DIS 11898-1:2024, for example. The clock can be up to 5 times less accurate than with CAN XL.

Another reason for the greatly reduced costs is that a protocol controller with significantly reduced functionality can be used in the responder subscriber station, which enables savings of more than 50%.

The reduced cost for the modified CAN XL transceiver or modified CAN SIC XL transceiver result from a lower semiconductor surface area requirement and a lower circuit design complexity. The semiconductor is in particular silicon, as mentioned above.

The configuration of the described transceiver of the present invention for a commander subscriber station or a responder subscriber station enables cost-effective integration of the responder on a single ASIC (application-specific integrated circuit) in a mixed semiconductor process, such as bipolar transistor(s) and CMOS transistor(s) and DMOS transistor(s) (BCD technology). The responder subscriber station (responder) send its function information, for instance a sensor value etc., to the commander subscriber station (commander) via a CAN XL message after receiving a polling from the commander.

The described transceiver of the present invention for a commander subscriber station or a responder subscriber station can be used for extended CAN XL light communication between the commander and the responder subscriber stations with bit rates that are higher than the currently possible bit rates with CAN FD. The bit rates are in particular greater than 10 Mbit/s, in particular up to 20 Mbit/s. The described communication between the commander and the responder subscriber stations thus enables significantly higher bit rates than with CAN FD light, with which only 2 Mbit/s or 5 Mbit/s can be achieved.

The resulting commander subscriber station and the responder subscriber station moreover enable the transmission of significantly larger data packets via the bus per message than with CAN FD light. The described responder subscriber station is configured to transmit 2048 bytes or more, in particular 4096 bytes, per message via the bus, whereas CAN FD light only permits 64 bytes.

Another additional advantage is that the described transceiver of the present invention for a commander subscriber station or a responder subscriber station enables a combination transceiver product that can serve both CAN XL light Extended and another standard for the transmission of differential signals, in particular 10BASE-T1S. This increases the range of possible applications and thus the flexibility for the user.

Overall, the described transceiver contributes to making bus system more cost-effective at data rates of up to 20 Mbit/s and data packets of approximately 2 kBytes or more in a message, while still enabling robust and reliable communication with differential signals.

Advantageous further embodiments of the transceiver of the present invention are disclosed herein.

It is possible that the operating mode switching module is configured to switch the transmitter module and the receiver module from the third operating mode into the first operating mode when the operating mode switching module has received a predetermined signal from the communication control device.

According to an example embodiment of the present invention, the transceiver can be configured to use a first physical layer in the first operating mode to generate only a first bus state on the bus, wherein the transceiver is configured to use a second physical layer that differs from the first physical layer in the second and third operating mode to generate a second and third bus state as respective symmetrical bus states for the differential signals on the bus.

It is possible that the only one bus state for differential signals on the bus in the first operating mode differs from each of the symmetrical bus states for differential signals on the bus in the two other operating modes for which the transceiver is configured in the two other operating modes.

The transceiver can be configured to switch on a predetermined reception threshold for generating a digital reception signal from the differential signal received from the bus when switching from the first operating mode to the third operating mode, but to switch off the predetermined reception threshold when switching from the third operating mode to the first operating mode.

The above-described transceiver can be part of a responder subscriber station for a serial bus system that also comprises a communication control device for controlling communication between the subscriber station and a commander subscriber station of the bus system and for evaluating at least one signal received from a bus of the bus system using a predetermined frame for a message from the bus, wherein the communication control device is configured to signal the transceiver at each bit of the predetermined frame, into which of the operating modes the transceiver is to be switched.

The communication control device can be configured to send a message to the commander subscriber station via the bus only if the commander subscriber station has requested the responder subscriber station to do so by means of a polling.

According to an example embodiment of the present invention, the responder subscriber station may also comprise an operating mode signaling module for signaling into which of three different operating modes the transceiver is to be switched, wherein the operating mode signaling module can be configured to signal a switchover of the operating mode at the beginning of the message in the transmission signal if the transceiver is to be switched to an operating mode for sending the message to the bus, and wherein the operating mode signaling module is configured to signal a switchover of the operating mode at the beginning of the message if the transceiver is to be switched to an operating mode for receiving the message from the bus.

The responder subscriber station may be configured to use a CAN XL frame in the XLFF format as the predetermined frame.

The above-described transceiver can be part of a commander subscriber station for a serial bus system that also comprises a communication control device for controlling communication between the subscriber station and a responder subscriber station of the bus system and for evaluating at least one signal received from a bus of the bus system using a predetermined frame for a message from the bus, wherein the communication control device is configured to signal the transceiver at each bit of the predetermined frame, into which of the operating modes the transceiver is to be switched.

According to an example embodiment of the present invention The communication control device of the commander subscriber station can be configured to prompt the responder subscriber station to send a message to the commander subscriber station via the bus by means of a polling.

The commander subscriber station may also comprise an operating mode signaling module for signaling into which of three different operating modes the transceiver is to be switched, wherein the operating mode signaling module can be configured to signal a switchover of the operating mode at the beginning of the message in the transmission signal if the transceiver is to be switched to an operating mode for sending the message to the bus, and wherein the operating mode signaling module is configured to signal a switchover of the operating mode at the beginning of the message if the transceiver is to be switched to an operating mode for receiving the message from the bus. The described commander subscriber station can support more than one frame format. The synchronization function can therefore be switched on or off at the commander subscriber station, in particular by setting the value of a configuration bit, for instance as mentioned above. If synchronization (resynchronization to the bit stream seen at the connection RXD) is switched off, the commander subscriber station no longer supports arbitration and can consequently only be used as a commander.

If the commander subscriber station does not have to be compatible with the current ISO 11898-1, the commander subscriber station can be designed more cost-effectively than a subscriber station that is compatible with ISO 11898-1. The reason for this is that there is no need for arbitration for communication between the commander and the responder on the bus and therefore no arbitration is required.

However, it is possible that the commander subscriber station also supports arbitration and can therefore communicate with other subscriber stations on the bus in accordance with the CAN CC, CAN FD, CAN XL and CAN FD/XL standards. For arbitration, the commander subscriber station has a low-tolerance or high-precision clock. In contrast, the responder subscriber station can have a high clock tolerance because the responder subscriber station is allowed to cause the majority, e.g. 90%, of the clock tolerance.

The above-described commander subscriber station of the present invention and at least one of the above-described responder subscriber stations of the present invention can be part of a bus system which comprises a bus and at least two subscriber stations, which are connected to one another via the bus such that they communicate in series with one another, wherein each of the at least two subscriber stations also comprises a transceiver for sending a transmission signal to the bus of the bus system and/or for receiving a signal from the bus of the bus system.

The aforementioned object may also achieved by a method for communication in a serial bus system according to certain features of the present invention. The method is carried out with an above-described commander subscriber station and an above-described responder subscriber station.

The method of the present invention provides the same advantages as those mentioned above with reference to the subscriber station.

Unlike a CAN XL subscriber station, this method of the present invention makes it possible that the commander subscriber station and the responder subscriber station do not carry out bit monitoring when sending a message; that the commander subscriber station does not send an ACK bit if the commander subscriber station has correctly received a message; that the responder subscriber station does not send an ACK bit if the responder subscriber station has correctly received a message; that the commander subscriber station and the responder subscriber station do not carry out error signaling; that the commander subscriber station and the responder subscriber station do not use overload frames; that the commander subscriber station and the responder subscriber station do not carry out an automatic retransmission, and that the commander subscriber station and the responder subscriber station do not automatically shut down the responder subscriber station upon detection of a predetermined number of communication errors.

Other possible implementations of the present invention also include not explicitly mentioned combinations of features or embodiments of the present invention described above or in the following with respect to the embodiment examples. The person skilled in the art will also add individual aspects as improvements or additions to the respective basic form of the present invention.

### BRIEF DESCRIPTION OF THE DRAWINGS

The present invention is described more detail in the following with reference to the figures and based on embodiment examples.

FIG. 1 shows a simplified block diagram of a bus system according to a first embodiment example of the present invention.

FIG. 2 shows the format of CAN XL frames according to the ISO/DIS 11898-1:2023 standard for a message that can be sent by a subscriber station of the bus system according to the first embodiment example of the present invention.

FIG. 3 shows a simplified schematic block diagram of a first subscriber station (commander) of the bus system according to the first embodiment example of the present invention.

FIG. 4 shows a temporal progression of a digital transmission signal during operation of the bus system at the first subscriber station which is connected to the same bus of the bus system with at least one second subscriber station, and when communication on the bus is based on the CAN XL standard.

FIG. 5 shows a temporal progression of bus signals CAN_H and CAN_L at the first subscriber station when the first subscriber station uses the CAN XL or CAN XL light standard to send the transmission signal of FIG. 4 to the bus.

FIG. 6 shows a temporal progression of a differential voltage VDIFF of the bus signals CAN_H and CAN_L on the bus as a result of the signals of FIG. 5.

FIG. 7 shows a temporal progression of a digital reception signal generated by the first or a second subscriber station from a signal received from the bus that is based on the transmission signal of FIG. 4.

FIG. 8 shows a temporal progression of a digital transmission signal during operation of the bus system at the first subscriber station during communication according to the first embodiment example, in which the first subscriber station uses CAN XL light Extended.

FIG. 9 shows a temporal progression of bus signals CAN_H and CAN_L at the first subscriber station according to the first embodiment example when the first subscriber station uses CAN XL light Extended.

FIG. 10 shows a temporal progression of a differential voltage VDIFF of the bus signals CAN_H and CAN_L on the bus as a result of the signals of FIG. 9.

FIG. 11 shows a simplified schematic block diagram of a second subscriber station (responder) of the bus system according to the first embodiment example of the present invention.

### DETAILED DESCRIPTION OF EXAMPLE EMBODIMENTS

In the figures, the same or functionally similar elements are provided with the same reference signs unless stated otherwise.

### Description of the Embodiment Examples

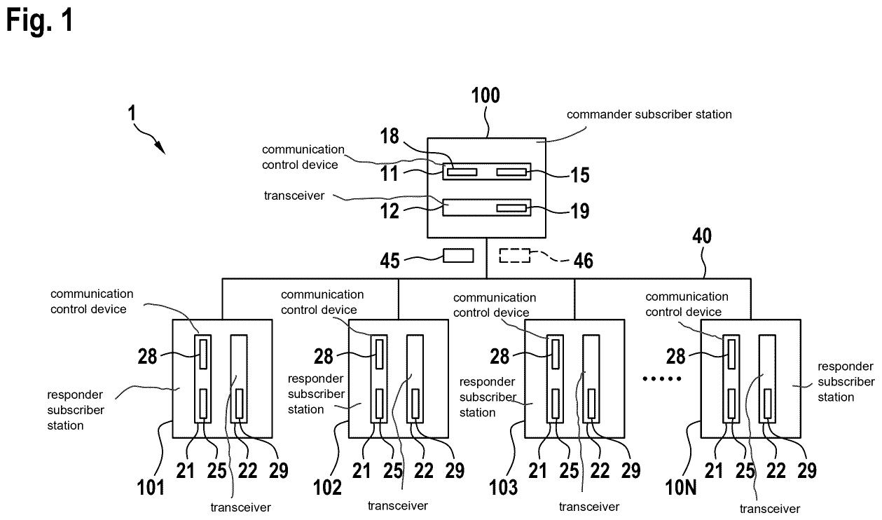

As an example, FIG. 1 shows a bus system 1 that is in particular configured to be the basis for a CAN XL bus system and/or modifications thereof as described in the following. The bus system 1 can be used in a vehicle, in particular a motor vehicle, an aircraft, etc., or in a hospital, etc.

In FIG. 1, the bus system 1 comprises a bus 40 to which a commander subscriber station 100 and a plurality of responder subscriber station(s) 101, 102, 103 . . . 10N are connected. N is a natural number greater than or equal to 1.

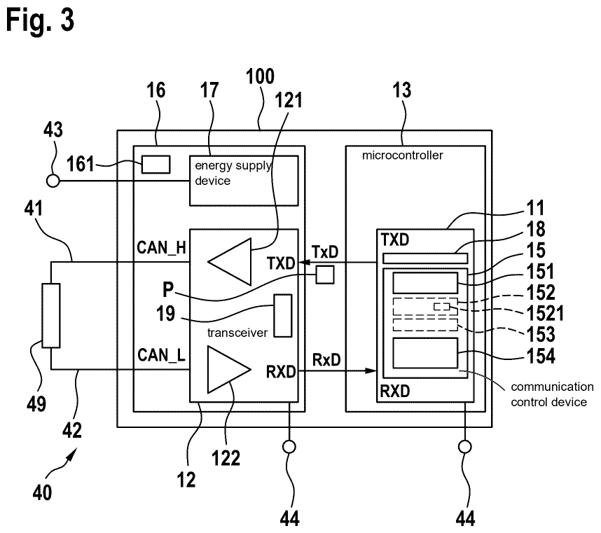

1 to N responder subscriber stations 101, 102, 103 . . . 10N are connected to the bus 40. The bus 40 can comprise a first bus wire 41 (FIG. 3) and a second bus wire 42 (FIG. 3) that are not shown in FIG. 1. The bus wires can also be referred to as CAN_H and CAN_L and are used for electrical signal transmission after coupling in the dominant levels or generating recessive levels or other levels for a signal in the transmission state.

The commander subscriber station 100 is, for instance, a control unit of a motor vehicle or some other technical system as described in more detail in the following. The responder subscriber stations 101, 102, 103 . . . 10N can, for example, comprise at least one sensor or at least one display device or at least one actuator or at least one encoder, etc. of a motor vehicle or other technical system as described in more detail in the following.

As shown in FIG. 1, the commander subscriber station 100 comprises a communication control device 11, a transceiver 12, a synchronization module 15, an operating mode signaling module 18 and an operating mode switching module 19. Each one of the responder subscriber stations 101, 102, 103 . . . 10N comprises a communication control device 21, a transceiver 22, a synchronization module 25, an operating mode signaling module 28 and an operating mode switching module 29.

The transceivers 12, 22 of the subscriber stations 100 . . . 10N are all connected directly to the bus 40 even though this is not shown in FIG. 1.

The commander subscriber station 100 is configured to create messages 45 in the form of signals. The commander subscriber station 100 can optionally be configured to alternatively create messages 46 for CAN FD or another CAN type. In the example described in the following, the commander subscriber station 100 is configured to send only messages 45 in the form of signals to one of the subscriber stations 101 . . . 10N via the bus 40.

In the example described in the following, the subscriber stations 101 . . . 10N in FIG. 1 are configured to create messages 45 in the form of signals and send them to the commander subscriber station 100 via bus 40. The messages 45 can be transmitted in series between the subscriber station 100 and one of the subscriber stations 101 to 10N.

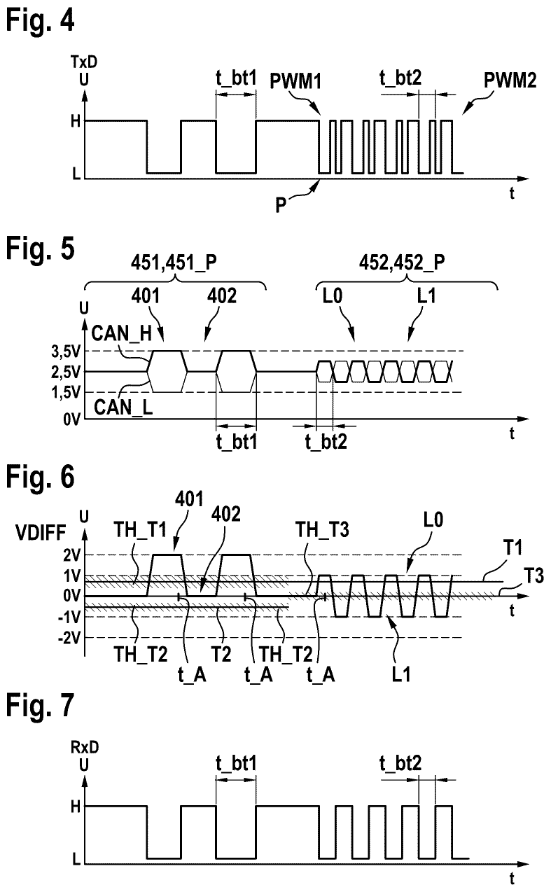

The communication control devices 11, 21 are all used to control communication between the subscriber station 100 and one of the subscriber stations 101 . . . 10N via the bus 40. If necessary, the communication control devices 11, 21 create a transmission signal TxD, which is described in more detail in the following with reference to FIG. 4. The communication control devices 11, 21 also read or decode a reception signal RxD, which is described in more detail in the following with reference to FIG. 7.

The communication control device 11 can be designed at least in part like a conventional CAN XL controller according to ISO/DIS 11898-1:2024 or like a conventional CAN XL light controller. Thus, depending on the design, the communication control device 11 can support the transmission and/or reception of 7 different frame formats, namely, 4 Classical CAN frame formats, 2 CAN FD frame formats with 11-bit or 29-bit identifiers, and 1 CAN XL frame format. The frame formats in particular for CAN FD are described in ISO 11898-1:2015 and are therefore not described in more detail here. The aforementioned frame formats are divided into two communication phases, an arbitration phase and a data phase as described in more detail in the following.

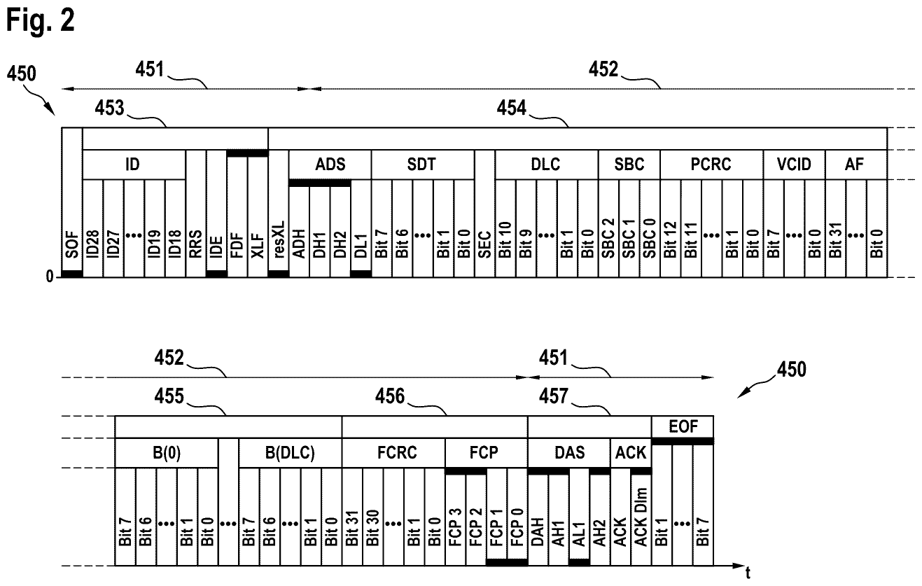

The communication control device 11 of FIG. 1 is configured such that it uses a CAN XL message 45 to communicate with the subscriber station 101 . . . 101N. The modules 18, 19 are used to send and receive the CAN XL message 45. The respective synchronization modules 15, 25 are optionally used as well. The CAN XL message 45 is based on a CAN XL format that is described in more detail with reference to FIG. 2. The synchronization modules 15, 25 are only required for bit rates greater than 1 Mbit/s. The operating mode signaling module 18 is used to signal to the transceiver 12 when sending the CAN XL message 45 that or when the transceiver 12 should switch its operating mode. The operating mode switching module 19 is used to switch the operating mode of the transceiver 12 as needed when sending or receiving the message 45 as described in more detail in the following.

The communication control device 21 is at least partly embodied as a CAN XL light controller. The synchronization module 25, which is configured such that it is compatible with the synchronization module 15, is provided for this purpose. The communication control device 21 creates messages 45, for example the CAN XL messages with a frame of FIG. 2, and is configured to read the messages 45 of the subscriber station 100. The operating mode signaling module 28 is used to signal to the transceiver 22 when sending the CAN XL message 45 that or when the transceiver 22 should switch its operating mode. The operating mode switching module 29 is used to switch the operating mode of the transceiver 12 as needed when sending or receiving the message 45 as described in more detail in the following.

The communication in the bus system 1 described in the following can also be referred to as CAN XL light Extended.

To communicate with the subscriber station 101 . . . 10N, the subscriber station 100 (commander) sends a polling to the subscriber station 101 . . . 10N via the bus 40. The polling is accomplished by sending a message 45 based on a CAN XL frame 450 shown in FIG. 2. A responder subscriber station 101 . . . 10N sends a message 45 based on an CAN XL frame according to FIG. 2 to the commander subscriber station 100 via the bus 40 only if the subscriber station 100 has prompted the responder subscriber station 101 . . . 10N to do so by means of a polling. The prompt to send is encoded in the frame 450 sent by the subscriber station 100 (commander); e.g. in a data field shown in FIG. 2 and described in the following.

In the CAN XL Light bus access method and in the method according to CAN XL light Extended, only the subscriber station 100 (commander) initiates communication with the responders. For this purpose, the subscriber station 100 (commander) sends a message 45 in a frame 450 according to FIG. 2. After completing the message 45, the subscriber station 100 (commander) can grant at least one of the N responders with a certain time window in which this one of the N responder subscriber stations 101 . . . 10N can send a message 45 and thereby respond to the polling. The subscriber station 100 (commander) can grant a certain time window in which up to N of the subscriber stations 101 . . . 10N (responders) can send a message 45 one after the other. The signals and thus the data from the subscriber stations 101 . . . 10N (responders) are therefore transmitted as the one channel in predetermined time intervals or time slots on the bus 40. For this purpose, each of the subscriber stations 101 . . . 10N (responders) is, for instance, configured to recognize and use a time slot intended for it.

With respect to the subscriber stations 101 . . . 10N, the subscriber station 100 therefore functions as a command transmitter/retriever and each of the subscriber stations 101 . . . 10N functions as a responder.

The CAN XL Light bus access method and the bus access method according to CAN XL light Extended are both a mixture of polling and time-division multiplexing methods. Time-division multiplexing methods are also referred to as TDM or time-division multiplexing methods or TDMA for time-division multiple access.

The subscriber station 100 can also be referred to in the following as the CAN XL light extended commander and the subscriber station 101 . . . 10N can be referred to as CAN XL light extended responders.

FIG. 2 shows a frame 450 that can be created by the subscriber station 100 or one of the subscriber stations 101 . . . 10N for a message 45 in the CAN XL frame format, which is also known as the XLFF format. The subscriber stations 100 . . . 10N are not limited to the frame 450 of FIG. 2, however, but can use a different frame for communication on the bus 40.

The CAN XL frame 450 according to FIG. 2 can be provided by the subscriber station (commander) 100 or the communication control device 11, specifically encoded in a digital transmission signal TxD, for the associated transceiver 12 to send the frame 450 to the bus 40 to another subscriber station of the bus system 1. The CAN XL frame 450 can alternatively be provided by a subscriber station (responder) 101 . . . 10N or its communication control device 21, specifically encoded in a digital transmission signal TxD, for the associated transceiver 22 to send to the bus 40.

The frame 450 is divided into two communication phases, which in CAN, CAN FD, and CAN XL are referred to as the arbitration phase 451 (first communication phase) and the data phase 452 (second communication phase). The frame 450 begins and ends in the arbitration phase 451, even if no arbitration takes place during communication on the bus 40, as described in more detail in the following.

In CAN XL light Extended, the subscriber stations 100 . . . 10N use symmetrical ‘1’ and ‘0’ levels for the transmission of the frame 450 on the bus 40 of FIG. 1 in both the first communication phase (arbitration phase) 451 and the second communication phase (data phase) 452, instead of recessive and dominant levels as in CAN ED and the arbitration phase 451 in CAN XL as described above.

The frame 450 of FIG. 2 begins with an SOF bit and comprises an arbitration field 453, a control field 454 with an ADS field for switching between the communication phases 451 and 452, a data field 455, a checksum field 456 (CRC field), an acknowledgment field 457 (ACK=acknowledge) and an end of frame field EOF (EOF=End of Frame). The CAN XL format is defined in ISO/DIS 11898-2:2024.

Bits in the first communication phase (arbitration phase) 451 of the frame 450 may have a longer bit time than bits of the second communication phase (data phase) 452. Switching from the bits with the bit time of the first communication phase (arbitration phase) 451 to the bits with the bit time of the second communication phase (data phase) 452 takes place at the beginning of the control field 454 in an ADH bit.

In CAN XL, CAN XL light and CAN XL light Extended, bits that are shown in FIG. 2 with a thick line at their lower line are sent in the frame 450 as dominant or ‘L0,’ in particular L=low or ‘0’. Bits that are shown in FIG. 2 with a thick line at their upper line are sent in the frame 450 as recessive or ‘L1,’ in particular H=high or ‘1’. Bits such as those shown in FIG. 2 with a thick line have a predetermined fixed or defined value in the frame 450.

The arbitration field 453 of the arbitration phase 451 is provided in CAN XL to carry out the arbitration for the frame 450 of FIG. 2 using the identifier (ID). In CAN XL light and CAN XL light Extended, however, the subscriber stations 100 . . . 10N do not carry out arbitration as mentioned above.

In the present embodiment example, a bit rate less than or equal to 20 Mbit/s is used in the first communication phase (arbitration phase) 451. Alternatively, however, the same bit rate can be used in the phases 451, 452. The latter will be the main use case in CAN XL light Extended in order to be able to use the fast transmission speed of up to 20 Mbit/s in the entire frame.

According to FIG. 2, the useful data of the CAN XL frame 450 or the message 45 are sent in the data phase 452 from the data field 455 and the checksum field 456 in addition to a part of the control field 454 of the frame 450. In the present embodiment example, a data bit rate that can in particular have values up to 20 Mbit/s is used in the data phase 452.

According to FIG. 2, the frame 450 includes an ADS field and a DAS field. In CAN XL, these two fields are used to switch the bit rate, and also to switch the transceiver 12 from the operating mode SIC to the operating modes FAST_TX or FAST_RX or from the FAST operating mode back to the operating mode SIC. In CAN XL light Extended, these fields only have the function to switch the bit rate if a slower bit rate was selected in the arbitration phase 451 than in the data phase 452.

In general, two different stuffing rules are used when generating the frame 450. The dynamic bit stuffing rule of CAN FD applies up to the FDF bit in the arbitration field 453 or for a frame 450 of FIG. 2 so that, after 5 identical bits in succession, an inverse stuff bit has to be inserted. In the data phase 452 up to the FCP field, a fixed stuffing rule applies, so that a fixed stuff bit that is inverse to the preceding bit has to be inserted after a fixed number of bits.

In the present embodiment example, in which the commander and the responders understand only CAN XL frames, the res bit from CAN FD and denoted in the frame 450 as the XLF bit, has no function for switching from the CAN FD format to the CAN XL format. The frame formats of CAN FD and CAN XL are identical up to the res bit or XLF bit, however. In CAN XL light Extended, the XLF bit is sent as 1, i.e. L1, in order to thus identify the frame 450 as the CAN XL frame. For a CAN FD frame, the communication control device 11 sets the bit to 0 or L (=LOW), i.e. as the dominant res bit. If the subscriber station 100 is at least partly a conventional CAN XL subscriber station, the subscriber station 100 also supports CAN FD. The subscriber stations 100 . . . 10N, on the other hand, are configured for CAN XL light Extended and only support frame 450 (CAN XL format) when sending and receiving.

The XLF bit is followed in the frame 450 by a resXL bit, which is a dominant bit for future use. The resXL has to be sent as 0, i.e. L0, for the frame 450 in CAN XL light Extended.

The resXL bit in the frame 450 is followed by an ADS sequence (Arbitration Data Switch) in an ADS field which is described above in connection with the DAS field.

The subsequent fields up to the beginning of the data field 455 are not described in more detail here. The data field 455 can have up to 2048 bytes or more. The length of the data field 455 is encoded in bits 0 to 10 of the DLC field.

The data field 455 in the frame 450 is followed by the checksum field 456 with a frame checksum FCRC and an FCP field. FCP=frame check pattern. The FCP field consists of 4 bits, in particular with the bit sequence 1100. A receiver of the frame 450 (receiving node) uses the FCP field to check whether the receiver (receiving node) is bit-synchronous with the transmit data stream. In addition, a receiving node synchronizes itself to the falling edge in the FCP field.

The FCP field is followed by the frame termination field 457. The frame termination field 457 consists of two fields, specifically the DAS field, as described above and in the following, and the acknowledgment field or ACK field with the at least one bit ACK and the bit ACK Dlm.

The DAS field has been described above.

As mentioned, in CAN XL light Extended, the physical layer is switched from recessive bus states to the physical layer for the bus states L0, L1 in order to transmit a message 45 between the subscriber stations 100 . . . 10N. In CAN XL light Extended, the switchover between the operating modes of the transceiver 12, 22 takes place at the beginning and the end of the frame. The communication control devices 11, 21 signal their associated transceiver 12, 22 by means of pulse-width modulation via the transmission signal TxD that a switchover is necessary.

The bit AH1 is followed by the bit AL1 (logical 0) and the bit AH2 (logical 1). The two bits DAH and AH1 ensure that all of the subscriber stations 100, 101 to 10N see a recessive level of significantly more than one arbitration bit time before the edge at the beginning of the bit AL1 (logical 0). This guarantees reliable synchronization for the subscriber stations of the bus system 1.

The sequence of the DAS field is followed In the frame termination field 457 by the acknowledgment field (ACK). In the acknowledgment field, bits are provided to acknowledge or not acknowledge correct reception of the frame 450. In CAN XL light Extended, a receiving subscriber station 100, . . . , 10N does not send transmission acknowledgments (ACK bit) with the value logical 0, which indicates a successful reception. Instead, a receiving subscriber station always sends the ACK bit as logical 1.

In the frame 450, the frame termination field 457 is followed by the end of frame field (EOF), as in CAN FD according to ISO 11898-1:2015.

The end of frame field (EOF) is followed in the frame 450 by an interframe space (IFS) which is not shown in FIG. 2. In CAN FD, this interframe space (IFS) is configured in accordance with ISO 11898-1:2015. The interframe space (IFS) has at least 3 bits.

The following applies for CAN XL.
Unlike CAN FD, the identifier ID of the frame 450 in CAN XL is called “Priority ID”.
Unlike CAN FD, CAN XL can send the RRS bit as (logical) 0 or as (logical) 1. In CAN FD, the RRS bit is always sent as logical 0.

FIG. 3 shows the basic structure of the subscriber station 100 with the communication control device 11, the transceiver 12 and the synchronization module 15 which is part of the communication control device 11. Also shown is the operating mode signaling module 18, which is at least partly part of the communication control device 11. The operating mode switching module 19, which is at least partly part of the transceiver 12, is shown as well.

According to FIG. 3, in addition to the communication control device 11 and the transceiver 12, the subscriber station 100 (commander) also comprises a microcontroller 13 to which the communication control device 11 is assigned, and a system ASIC 16 (ASIC=application-specific integrated circuit). The system ASIC 16 can alternatively be a system basis chip (SBC), on which multiple functions needed for an electronic assembly of the subscriber station 100 are combined. The system ASIC 16 in particular comprises an application 161 that can be configured as a computer program (app) or software. One such application is a technical application 161. The application 161 is any application in a vehicle, for example. The application is in particular a windshield washer system and/or driver assistance system, etc. The windshield washer system, for instance, controls the movement of at least one windshield wiper (actuator) using data from a rain sensor and/or wind sensor and/or speed sensor and/or light sensor and/or it can switch a warning light (actuator) on or off. The application is not limited to a windshield washer system or parts thereof, however.

In addition to the transceiver 12, the system ASIC 16 also includes an energy supply device 17 which supplies electrical power to the transceiver 12. The energy supply device 17 typically supplies a CAN_Supply voltage (VCC) of 5 V. Depending on requirements, however, the energy supply device 17 can supply a different voltage with a different value. Additionally or alternatively, the energy supply device 17 can be configured as a current source.

To communicate with one of the subscriber stations 101 . . . 10N, the communication control device 11 creates a frame 450, in which bit rate switching can take place in the ADS, DAS fields of FIG. 2 as described above, and/or evaluates such a frame 450. For this purpose, a standard CAN XL communication control device in accordance with ISO/DIS 11898-1:2024 having the additional functions can be used for the device 11 as described above or in the following. It is thus possible to achieve a data bit rate with values of in particular up to 20 Mbit/s in the data phase 452. When the communication control device 11 is configured as a CAN XL light Extended commander, the bit rate switching can be switched on or off. Switched off means that the user sets the same bit rate for the first communication phase (arbitration phase) 451 and the second communication phase (data phase) 452. In this case too, the bit rate can reach up to 20 Mbit/s.

According to FIG. 3, the synchronization module 15 comprises a synchronization block 151, optionally a configuration block 152, optionally an evaluation block 153 and a switching block 154. In particular a value for at least one synchronization configuration bit 1521 can be stored in the optional configuration block 152. The synchronization block 151 can be the bit timing control unit BTL of the communication control device 11.

The synchronization module 15, in particular the evaluation block 153 and the switching block 154, can be implemented at least partly as software.

The synchronization block 151 has a synchronization function described in ISO/DIS 11898-2:2024. This synchronization function can be switched as needed, however; as will be described in more detail in the following.

The transceiver 12 comprises a transmitter module 121 and a receiver module 122. Even if the following always refers to the transceiver 12, it is alternatively possible to provide the receiver module 122 in a separate device external to the transmitter module 121. The transmitter module 121 and the receiver module 122 can be structured as in a conventional CAN SIC XL transceiver 12 which has the additional functions as described above or in the following. The transmitter module 121 can in particular comprise at least one operational amplifier and/or a transistor. The receiver module 122 can in particular comprise at least one operational amplifier and/or a transistor.

The transceiver 12 is connected to the bus 40; more specifically to its first bus wire 41 for CAN_H and its second bus wire 42 for CAN_L.

The voltage supply for the energy supply device 17 for supplying the first and second bus wire 41, 42 with electrical energy, in particular with the CAN supply voltage, is provided via at least one connection 43. The connection to ground or CAN_GND is realized via a connection 44. The first and second bus wire 41, 42 are terminated with a terminating resistor 49.

The first and second bus wire 41, 42 are connected in the transceiver 12 not only to the transmitter module 121, which is also referred to as the transmitter, but also to the receiver module 122, which is also referred to as the receiver, even though the connection is not shown in FIG. 3 for the sake of simplicity.

During operation of the bus system 1, the transmitter module 121 of FIG. 3 can serially convert a transmission signal TxD of the communication control device 11, for example the transmission signal TxD of FIG. 4, into corresponding signals CAN_H, CAN_L for CAN XL or its modifications for the bus wires 41, 42 and can send these signals to the bus 40 at the connections for CAN_H and CAN_L.

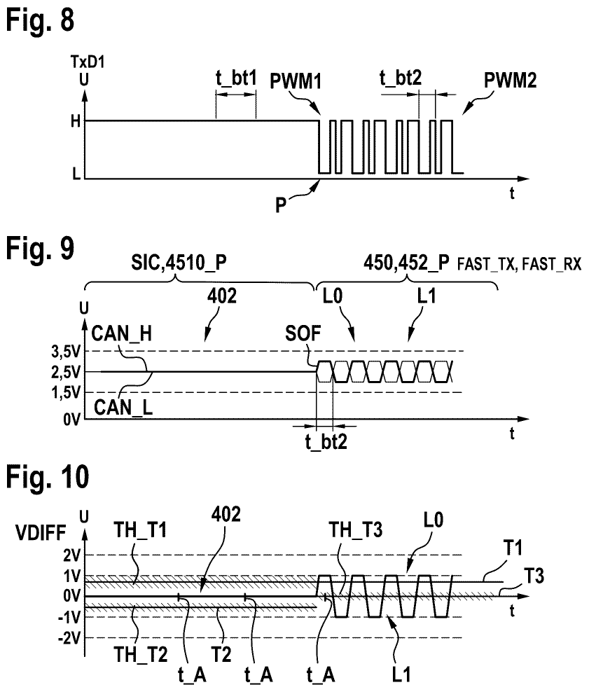

The communication control device 11 sends the transmission signal TxD of FIG. 4, if communication according to XL light is possible in the bus system 1, or a transmission signal TxD1 of FIG. 8, if communication according to XL light Extended is possible in the bus system 1, over time t (serially) via the connection TXD to the transmitter module 121, as shown in FIG. 3. As shown as an example in FIG. 4, the transmission signal TxD has the voltage states H (High) and L (Low) with a corresponding voltage U. On the right side of FIG. 4, the signal TxD is pulse-width modulated with a first symbol PWM1 and a second symbol PWM2 in the transmission signal TXD. The second symbol PWM2 differs here from the first PWM symbol PWM2, as shown in FIG. 4 for example.

According to the example of FIG. 5, the subscriber station 100 can be configured for communication according to CAN XL light to generate signals CAN_H and CAN_L, which have the dominant and recessive bus levels 401, 402 according to a first physical layer 451_P, for a frame 450 of FIG. 2 in the arbitration phase 451 as from CAN XL. The subscriber station 100 can also be configured for communication according to CAN XL light to generate the bus levels L0, L1 according to a second physical layer 452_P for the frame 450 of FIG. 2 in the data phase 452 as from CAN XL.

The left side of FIG. 5 shows that, in CAN XL light, the subscriber station 100 can send signals CAN_H CAN_L that have a first bit time t_bt1 to the bus 40 over time t in the first communication phase 451. The signals CAN_H, CAN_L are serial signals and alternately have at least one dominant state 401, in which, at a supply voltage VCC=5 V, VCAN_H=3.5 V and VCAN_L=1.5 V, or at least one recessive state 402, in which VCAN_H=VCAN_L=2.5. In the case of NRZ encoding of the transmission signal TxD, a dominant state 401 (dom) is driven in the phase 451 if TXD=0 or LOW (FIG. 5). A recessive state 402 (rec) is generated or established during NRZ encoding of the transmission signal TxD in the phase 451 if TXD=1 or HI (HIGH) (FIG. 5).

As shown on the right side of FIG. 5, during pulse-width modulation (PWM encoding) of the transmission signal TXD for the first PWM symbol PWM1 in the transmission signal TXD, the state L0 (VCAN_H=3.0 V, VCAN_L=2.0 V at VCC=5 V) is driven. During pulse-width modulation (PWM encoding) of the transmission signal TXD, the state L0 VCAN_H=2.0 V and VCAN_L=3.0 V at VCC=5 V is driven for the second PWM symbol. The states L0, L1 have the bit time t_bt2 which is shorter than the bit time t_bt1.

FIG. 6 shows a differential signal VDIFF=CAN_H−CAN_L that forms on the bus 40. The individual bits of the signal VDIFF with the bit time t_bt1 can be detected by the transceivers 12, 22 in the arbitration phase 451 with a reception threshold T1 of, 0.7 V, for example, which lies within a range of TH_T1, as from CAN XL. With an optional reception threshold T2 of −0.3 V, for instance, which can only be switched on in the arbitration phase 451 and lies within a range of TH_T2, for example, the transceivers 12, 22 detect whether or not the bus levels L0, L1 are being sent on the bus 40. With the optional reception threshold T2, a subscriber station 100 that is switched to the operating mode of the arbitration phase 451 detects whether bus levels L0, L1 of the data phase 452 are present on the bus 40. In the communication phase (data phase) 452, the transceivers 12, 22 detect the individual bits of the signal VDIFF with a reception threshold T3, for example 0.0 V, that lies within a range of TH_T3, as from CAN XL.

The sequence of the states H, L of the transmission signal TxD of FIG. 4 and the resulting states 401, 402 for the signals CAN_H, CAN_L in FIG. 5 as well as the resulting progression of the voltage VDIFF of FIG. 6 serve only to illustrate the function of the subscriber station 100. The sequence of the data states for bus states 401, 402 can be selected as needed.

The receiver module 122 creates a reception signal RxD from signals CAN_H and CAN_L received from the bus 40, which are shown in FIG. 5, or the differential voltage VDIFF of FIG. 6. To generate the digital reception signal RxD of FIG. 7, the receiver module 122 uses the reception thresholds T1, T2, T3, as described above. The reception signal RxD is shown in FIG. 7 without propagation delay. The receiver module 122 passes this reception signal RxD to the associated communication control device 11 as shown in FIG. 3.

The reception thresholds T1 and T2 are used to detect whether the bus 40 is free when the subscriber station 12 is newly connected to the communication on the bus 40 and is attempting to integrate itself into the communication on the bus 40.

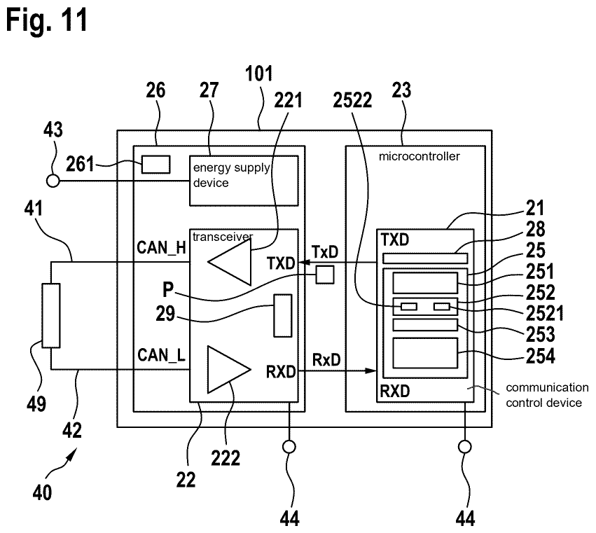

If the CAN XL light Extended-capable subscriber stations 100, 101, . . . , 10N use the operating mode switching of the operating mode switching module 19 for their transceiver 12, 22, the transmitter of a frame 450 generates a transmission signal TxD1 according to FIG. 8, so that, for a message 45 based on a frame 450 of FIG. 2, the signals of FIG. 9 and FIG. 10 are generated on the bus 40 instead of the signals of FIG. 5 and FIG. 6. For the sake of simplicity, the propagation delays of the signals of FIG. 5 to FIG. 7 compared to the transmission signal of FIG. 4 are not shown in the figures. The propagation delays of the signals of FIG. 9 and FIG. 10 compared to the transmission signal of FIG. 8 are not shown in the figures either for the sake of simplicity.

The subscriber stations 100 . . . 10N are therefore configured for communication according to CAN XL light Extended, as specified in the following for the subscriber stations 100 (commander) and as an example for the subscriber station 101 (responder).

TABLE 1
Communication status of the subscriber stations
100 . . . 10N in CAN XL light Extended

| | Subscriber station | | Subscriber station | |
|---|---|---|---|---|
| | 100 | | 101 | |
| | Action | | Action | |
| | status, | Driven | status, | Driven |
| | operating | bus | operating | bus |
| Communication status | mode | state | mode | state |
| No communication | Receive | 402 | Receive | 402 |
| | (SIC) | (Rec) | (SIC) | (Rec) |
| Subscriber station 100 | Transmit | L0, L1 | Receive | 402 |
| transmits (Phase 451) | (FAST_TX) | | (FAST_RX) | (Rec) |
| Subscriber station 101 | Receive | 402 | Transmit | L0, L1 |
| transmits | (FAST_RX) | (Rec) | (FAST_TX) | |
| (Phase 451) | | | | |

Symmetrical bus states L0, L1 therefore exist only in the operating mode FAST_TX. Each of the subscriber stations 101 . . . 10N transmits with high impedance (REC) in the operating mode FAST_RX, but each of the subscriber stations 101 . . . 10N adjusts its reception threshold to OV in the operating mode FAST_RX in order to be able to decode the bus states L0, L1.

As shown in FIG. 9, in the event of non-communication or idle time on the bus 40, the transceiver 12, 22 uses the first operating mode SIC of a CAN XL SIC subscriber station. The transceivers 12, 22 use a physical layer 4510_P, in which only recessive states 402 (Rec) are generated on the bus 40. The transceivers 12, 22 furthermore use the second physical layer 452_P as the transmitter for the entire frame 450 to send a transmission signal TxD (FIG. 8) over time t as signals CAN_H, CAN_L to the bus 40. There are two operating modes for the physical layer 452_P, namely, FAST_TX and FAST_RX, as described above.

During communication according to CAN XL light Extended in the bus system 1, the transceivers 12, 22 use the reception threshold T1, and optionally the reception threshold T2, when there is no communication, i.e. in the operating mode SIC. As receivers of a frame 450, i.e. in the operating mode FAST_RX, the transceivers 12, 22 use only the third reception threshold T3 of approximately 0.0 V. The third reception threshold T3 of approximately 0.0 V is therefore switched off when there is no communication on the bus 40. This deactivation of the third reception threshold T3 prevents recessive states 402 (Rec) on the bus 40 from leading to the ascertainment of false states on the bus 40.

Although not shown in FIG. 9 and FIG. 10, the bits of the signals CAN_H and CAN_L can be transmitted at least temporarily slower in the communication phase 452 of frame 450 than with the bit time t_bt2, as described above. The signals CAN_H and CAN_L in CAN XL for the frame 450 in the communication phase 452 thus differ from the conventional signals CAN_H and CAN_L in Classical CAN at least in their bus states L0, L1 and optionally also in their faster bit rate.

Each of the subscriber stations 100, 101, . . . , 10N can transmit and/or receive. Only in the following example, it is assumed here that the subscriber stations 101, . . . , 10N are receivers of the currently transmitted frame 450.

Assuming the subscriber station 100 (commander) sends a frame 450 to the bus 450, the communication control device 11, in particular the operating mode signaling module 18, then sends a signal using a pulse-width modulated symbol P to its transceiver 12 starting from the SOF bit of the transmission signal TxD1 of FIG. 8. The symbol P can be defined as a PWM symbol PWM1 or as a PWM symbol PWM2. Another PWM symbol can alternatively be used. The symbol P signals the transceiver 12 that it has to switch its operating mode SIC, in which the bus state 402 (rec) is generated, to the operating mode FAST_TX in order to send the subsequent bits of the frame 450 serially to the bus 40.

The transceiver 12 thus switches the physical layer 4510_P, in which the bus state 402 (rec) is generated, to the physical layer 452_P.

As shown in FIG. 9, the transmitter module 121 of the subscriber station 100, as the transmitter, then, starting from the SOF bit, switched to the second operating mode (FAST_TX) and depending on the transmission signal TxD1 of FIG. 8, successively and thus serially generates the states L0 or L1 with the physical layer 452_P for the signals CAN_H, CAN_L on the bus 40. The signals CAN_H, CAN_L on the bus 40 are delayed by the time needed by the transmitter module 121 to decode and send the transmission signal TxD1 of FIG. 8 to the bus 40. FIG. 10 shows the resulting differential signal VDIFF on the bus 40.

In CAN XL light Extended, the transmitter module 121 of the subscriber station 100 also generates the SOF bit as a PWM symbol for the bus state L0, as shown in FIG. 8 and FIG. 9, and sends it to the transceiver 12. The PWM symbol is decoded by the transceiver 12, in particular its operating mode decoding module 19. Based on the PWM symbol for the bus state L0, the transceiver 12 switches to the operating mode FAST_TX. Before that, the transceiver 12 is switched to the operating mode SIC, in which the transceiver 12 always transmits the bus state recessive. Because the decoding of a PWM symbol is always possible only at the end of the PWM symbol, the transceiver 12 sends the L0/L1 bus states with a delay equal to the length of one PWM symbol. In FIG. 9, therefore, the SOF bit is further to the right by the length of a PWM symbol than in FIG. 8.

In the present example, the subscriber station 100 (commander) is thus the transmitter of the frame 450. Consequently, the subscriber station 101 is the receiver of the frame 450, i.e. not a transmitter. The same applies to the responder subscriber stations 102 . . . 10N. Upon receipt of a bus state L0 (alternatively L1) according to the signal of FIG. 10 due to the detection of one of the reception thresholds T1 (alternatively T2), the transceivers 22 of the subscriber stations 101 . . . 10N therefore switch their physical layer for the communication phase 452, specifically from the physical layer 4510_P of the first operating mode SIC to the physical layer 452_P of the third operating mode FAST_RX of the transceiver 22.

The following applies at the end of the frame 450: At the end of the frame 450, the communication control device 11, more specifically its operating mode signaling module 18, stops PWM encoding and no longer sends PWM symbols. If the transceiver 12 detects at its connection TXD for a transmission signal TxD1 that PWM encoding has ceased, the transceiver 12 is switched from sending (operating mode FAST_TX) signals with the physical layer 452_P to the operating mode SIC, in which the physical layer 4510_P is used. The transceiver 12 is configured such that only the reception threshold T1 (alternatively T2) is active in the operating mode SIC. The reception threshold T3=approximately 0.0 V is therefore deactivated or switched off.

At the end of the frame 450, the communication control device 21, more specifically its operating mode signaling module 28, stops PWM encoding and no longer sends PWM symbols. If the transceiver 22 detects that PWM encoding has ceased, it switches its receive operating mode (FAST_RX) to the first operating mode (SIC). The switch means that the transceivers 22 deactivate or switch off their reception threshold T3=approximately 0.0 V and activate T2.

When the corresponding signals are received from the bus 40, each transceiver 12 generates the associated reception signal RxD, as shown in FIG. 7 and described above.

The subscriber station 100 is thus configured like a conventional CAN XL subscriber station with the additional functions described above.

Via the configuration of the data field and/or the selection of the identifiers (ID) of the subscriber stations 100 (commanders) and the subscriber stations 101 . . . 10N, the user ensures that the subscriber station 100 operates as a CAN XL light extended commander and the subscriber stations 101 . . . 10N operate as CAN XL light extended responder according to the polling principle. The subscriber station 100 (commander) is therefore permitted to send messages 45 of each of the subscriber stations 101 . . . 10N (responders). The subscriber station 100 (commander) encodes in the message 45 whether the responder should reply or not. The responder is permitted to send a message only if there is a prior request and using the specific time window in which up to N of the subscriber stations 101 . . . 10N (responders) can successively send a message 45.

Optionally, the subscriber station 100 (commander) can proceed as follows.

During operation of the bus system 1, the subscriber station 100 (commander), more specifically the communication control device 11, carries out bus monitoring. In accordance with ISO 11898-1:2015, the subscriber station 100, in particular the communication control device 11, compares its own bits transmitted according to a frame 450 and a transmission signal TxD (FIG. 5 or FIG. 8) at a sample point t_A with the bits according to the reception signal RxD (FIG. 7) observed on the bus 40. Except in the case of arbitration and the ACK bit, a difference is considered an error.

In accordance with the preset software configuration, however, the subscriber station 100 (commander), more specifically the communication control device 11, switches the bus monitoring off for short bit times t_bt1, t_bt2 if the subscriber station 100 (commander) is the sender of the message 45. The short bit rates can occur in the arbitration phase 451 and/or the data phase 452. Such short bit times occur at bit rates above 1 Mbit/s, at which the so-called loop delay of the subscriber station 100 (CAN node) comes into the range of half a bit time t_bt1, t_bt2 or more. The so-called loop delay indicates the time that elapses until the subscriber station 100 can see the bit of the transmission signal TxD sent via the connection TXD internally as the reception signal RxD.

The subscriber station 100 (commander), more specifically the communication control device 11, also carries out a synchronization function for all frames 450 received by the subscriber station 100 (commander) from one of the responders 101 . . . 10N during operation of the bus system 1 using the synchronization block 151.

The synchronization block 151 observes the edges from recessive to dominant or vice versa, i.e. a change between the states 401, 402, or 402, 401 in FIG. 6 or FIG. 7 or FIG. 9 and FIG. 10. Based on the observed edges, the synchronization block 151 synchronizes the position of the sample point t_A within a bit time t_bt1 (FIG. 5 and FIG. 6). A receiver thus synchronizes itself to the transmitter of a frame 450. If an edge ideally occurs at the beginning of a bit time t_bt1, t_bt2, there is no need for synchronization because edge changes can occur at the beginning of a bit time. If an edge occurs between the beginning of a bit time t_bt1, t_bt2 and the sample point t_A, a so-called late edge occurs. This causes a synchronization, in which the current bit time t_bt1, t_bt2 is extended. If an edge occurs between the sample point t_A and the end of a bit time t_bt1, t_bt2, a so-called early edge occurs. This causes a synchronization, in which the current bit time t_bt1, t_bt2 is shortened.

According to ISO 11898-1:2015, transmitters of a frame 450 synchronize as well. However, there is the restriction that a subscriber station 100 that sends a dominant bit does not synchronize to late edges. The reason for this is that, due to the loop delay, the transmitter sees all of its own transmitted bits late. Synchronization to these late edges, which were sent by the subscriber station itself, would therefore extend these bits and distort the bit rate. The permitted synchronization to early edges stabilizes the CAN arbitration at the beginning of the frame 450. This is necessary in particular when arbitration is taking place. In CAN XL light Extended, there is no arbitration.

The synchronization function is described in more detail in ISO 11898-1:2015.

With the synchronization module 15, the synchronization function of the synchronization block 151 can be switched as needed, however, as described in the following.

The evaluation block 153 is configured to evaluate the synchronization configuration bit 1521 in the configuration block 152. The synchronization configuration bit 1521 is set when the subscriber station 100 (commander), more specifically the communication control device 11, is to send the frame 450 with a bit time t_bt1 of the first communication phase 451 of CAN XL which corresponds to a bit rate that is greater than a predetermined bit rate. The predetermined bit rate is in particular greater than 1 Mbit/s.

If the evaluation of the evaluation block 153 shows that the synchronization configuration bit 1521 is set, the evaluation block 153 checks whether the subscriber station 100 (commander), more specifically the communication control device 11, should (currently) act as a transmitter, i.e. send a frame 450 to a responder to the bus 40. The synchronization configuration bit 1521 is set together with the bit rate configuration, for instance, either via software or hardwired. During operation of the bus system 1, the configuration bit 1521 is then constant.

If the evaluation of the evaluation block 153 shows that the subscriber station 100 (commander), more specifically the communication control device 11, should act as a transmitter and send a frame 450 to the bus 40 to a responder, the evaluation block 151 instructs the switching block 154 to switch the synchronization block 151 off. The switching block 154 therefore switches the synchronization block 151 and thus its above-described synchronization function off for all bits of the frame 450 to be sent to the bus 40 from the subscriber station 100 as the commander up to the last bit of the end field (EOF).

Switching off the synchronization block 151 prevents the transmitter from synchronizing to its own transmitted edges, that it does not see within the transmitted bit, but in one of the subsequent bit times.

Synchronization can be switched off, since arbitration cannot occur because arbitration is no longer possible at this bit rate t_b1 of over 1 Mbit/s.

After the last bit of the end field (EOF) of the transmitted frame, the switching block 154 of FIG. 4 switches the synchronization block 151 and thus its above-described synchronization function back on again.

It is also possible to deactivate the need to send an acknowledgment response (ACK bit or ACK response) for a message 45 from a responder (subscriber station 101 . . . 10N) at the subscriber station 100 (commander). The need to receive an acknowledgment response (ACK bit or ACK response) for a message 45 sent by it to a responder (subscriber station 101 . . . 10N) can be deactivated at the subscriber station 100 (commander) as well.

According to FIG. 11, in addition to the communication control device 21 and the transceiver 22, the responder subscriber station 101 also comprises a simple control unit (FSM) or optionally a microcontroller 23 to which the communication control device 21 is assigned, and a system ASIC 26 (ASIC=application-specific integrated circuit), which can alternatively be a system basis chip (SBC), on which a plurality of functions necessary for an electronic assembly of the subscriber station 101 are combined. The system ASIC 26 in particular comprises an application 261 that can be configured as a computer program (app) or software. One such application is a technical application 261.

The application 261 is a control for a sensor, for instance, or an encoder or an actuator or the like, which is controlled by the application 161 (FIG. 3) of the commander subscriber station 100 or is intended to provide data for the application 161.

The responders have little or no local computing power and can execute simple functions, e.g. switching a light-emitting diode (LED) on/off or controlling the color of a light-emitting diode (LED), as described above. A responder only sends a frame 450 if it has been requested to do so by the commander via polling. After receiving a polling from the commander, the responder CAN subscriber stations (responders) thus send their function information, for instance a sensor value etc., to the commander CAN subscriber station (commander) via a CAN XL message.

According to FIG. 11. in addition to the transceiver 22, the system ASIC 26 also includes an energy supply device 27 which supplies electrical power to the transceiver 22. The energy supply device 27 typically supplies a CAN_Supply voltage of 5 V. Depending on requirements, however, the energy supply device 27 can supply a different voltage with a different value. Additionally or alternatively, the energy supply device 27 can be configured as a current source.

The communication control device 21 creates a frame 450 in which bit rate switching or bit rate change can occur, as described with reference to FIG. 2, and/or evaluates such a frame 450 based on the frame 450 received from the commander subscriber station 100. The communication control device 21 acts as a CAN XL light extended responder. The devices 21, 22 can send such a frame 450 to the bus 40 only after a request from the commander subscriber station 100 (polling).

As described above, the operating mode signaling module 28 signals the transmitter module 221 by means of a PWM symbol P at the connection TXD or in a TxD signal that the bus state rec should be changed to bus levels L0, L1 according to the states L, H or 0, 1 in the TxD signal when a message 45 is to be sent.

The operating mode switching module 29 also switches on the reception threshold T3 in the receiver module 222 when the reception threshold T1 (=approximately +0.6 V) is exceeded. The operating mode switching module 29 switches the reception threshold T3 off again, in particular in the DAS field or at the end of the frame 450 (after the EOF (7 bit)), as described above. The fact that the reception threshold T3 should be switched off is detected by the absence of the PWM encoding at the connection TXD.

During operation of the bus system 1, the responder subscriber station 101 carries out the following procedure if the responder subscriber station 101 is currently the receiver. However, each one of the subscriber stations 100 . . . 10N (commander and responder) is configured in the same way and behaves as a receiver in the same way as described in the following.

An edge on the bus 40, in which the reception threshold T1 (=approximately 0.7 V or approximately 0.6 V) is exceeded, switches the transceiver 22 to the operating mode FAST_RX. In operating mode FAST_RX, the operating mode switching module 29 switches on the reception threshold T3 (=approximately 0.0 V) at the receiver module 222.

The transceiver 22 passes the bus signal which, due to the start bit (SOF), corresponds to a transmission signal TxD of logical 0 to the connection RXD and thus on to communication control device 21.

Due to the edge from 1 to 0 of the SOF bit at the connection RXD, the communication control device 21 recognizes that it is supposed to receive something.

The communication control device 21 therefore instructs the operating mode signaling module 29 to signal the transceiver 22 to switch to the operating mode FAST_RX. This signaling serves to ensure that the transceiver 22 remains in the operating mode FAST_RX as long as the signaling continues.

At the end of the frame 450, which is known to the communication control device 21, the communication control device 21 switches the operating mode signaling off. The transceiver 22 therefore switches or goes into the operating mode SIC.

The transmitter module 221 of FIG. 10 is otherwise structured in the same manner as described above for the transmitter module 121 of FIG. 3.

The synchronization module 25 of FIG. 10 comprises a synchronization block 251, a configuration block 252, an evaluation block 253 and a switching block 254. At least one configuration bit 2521, 2522 is stored in the configuration block 252.

The synchronization module 25, too, can switch off synchronization for frames 450 or messages 45 sent by the subscriber station 101 as described above with reference to FIG. 3 for the synchronization module 15 for frame 450. The synchronization module 25 therefore always switches off synchronization for frames 450 or messages 45 sent by the subscriber station 101 at high bit rates. The high bit rates are greater than 1 Mbit/s, for example.

In contrast to the synchronization module 15 of FIG. 3, the synchronization module 25 of FIG. 10 is optionally configured to switch off synchronization for frames 450 or messages 45 sent by the subscriber station 101 in the associated responder even at low bit rates, if desired. For this purpose, an additional configuration bit 2522 can be set, for instance. The low bit rates are less than or equal to 1 Mbit/s, for example. This switching off does not have a significant effect on the communication between the commander subscriber station 100 and the respective responder subscriber station 101 . . . 10N.

This makes it possible to select the synchronization module 25 of FIG. 11 to optionally be configured to switch off its synchronization function for frames 450 or messages 45 sent by the subscriber station 101 at both low and high bit rates. In other words, it is possible to select the synchronization module 25 of FIG. 10 to be configured to switch off its synchronization function for frames 450 or messages 45 sent by the subscriber station 101 independently of the bit rate.

The subscriber stations 101 . . . 10N can forgo these synchronizations because no arbitration takes place in CAN XL Light and CAN XL light Extended or during communication with the commander subscriber station 100 and, also, no ACK bit is sent at higher bit rates.

Otherwise, the synchronization module 25 is structured in the same way as described above for the synchronization module 15.

The synchronization modules 15, 25 thus have the effect that communication with CAN XL Light is possible even at bit rates greater than or equal to 1 Mbit/s.

The subscriber stations 101 . . . 10N (responders) thus comprise a CAN XL light protocol controller that is additionally or alternatively configured for the above-described functions of CAN XL light Extended.

The CAN XL implementation of the communication control device 21 is adapted for this purpose. The adaptations are designed to simplify or reduce functionality in order to lower the resource requirements. Among other things, the following adaptations are available, for instance:
Bit monitoring when sending a message 45 is not available in the communication control device 21 or is disabled. This is possible because CAN XL light and CAN XL light Extended do not require arbitration and also cannot send error frames. The lack of arbitration makes it possible to place the sample point t_A further toward the center of the bit as shown in FIG. 10, and thus allow a greater tolerance for the accuracy of the CAN clock. The “transmitter delay compensation” function can moreover likewise be optimized away or omitted because it is only used for bit monitoring in the data phase when transmitting a frame 450 and bit monitoring is no longer used.

Signaling via error frames and overload frames is also not available or is disabled in the communication control device 21. This is possible because immediate error signaling is not necessary in CAN XL Light and CAN XL light Extended.

The communication control device 21 furthermore does not carry out an automatic retransmission. Because CAN XL Light and CAN XL light Extended cannot resolve collisions on the bus 40 by means of arbitration, a CAN XL Light subscriber station 101 . . . 10N (responder) cannot automatically repeat the transmission of a message.

It is moreover also possible to omit fault confinement in the communication control device 21. CAN XL, CAN FD, and Classical CAN (CC) provide that a subscriber station on the CAN bus is automatically switched off if the subscriber station detects too many communication errors. This ensures that a faulty subscriber station does not interfere with the communication of other subscriber stations. Since, in CAN XL Light and CAN XL light Extended, the responder only sends a frame 450 if requested to do so by the commander via the frame 450, there is no need for automatic node switch-off.

Just as the communication control device 11 of the commander can be configured according to the description of FIG. 3, the communication control device 21 of the responder is also configured for high bit rates, specifically greater than 1 Mbit/s, in the arbitration phase 451
to not send an ACK bit if the device 21 has correctly received a message 45, and
to not carry out synchronization to the seen reception signal RxD (FIG. 7) while transmitting a frame 450.

In contrast to the communication control device 11 of the commander, however, the communication control device 21 of the responder is configured to only support or transmit and/or receive CAN frames in the XLFF format (XL base frame format).

A CAN XL light extended responder can thus optionally be configured to only send and receive frames in one format (XL), specifically frame 450 according to FIG. 2.

The limitation to a single frame format significantly reduces the implementation effort of the CAN XL light extended responder, in particular its communication control device 21.

According to a second embodiment example, the transceiver 12, 22 is configured to use levels other than the L0, L1 level of FIG. 10 for the above-described communication on the bus 40 according to CAN XL light Extended. Such other levels could, for instance, be L0, L1 levels according to the 10BASE-T1S standard.

The transceivers 12, 22 are therefore configured to generate the differential signals CAN_H, CAN_L on the bus 40 such that the differential voltage VDIFF for a bus state L0_10BASE has a voltage of approximately +0.5 V. The transceivers 12, 22 are also configured to generate the differential signals CAN_H, CAN_L on the bus 40 such that the differential voltage VDIFF for a bus state L1_10BASE has a voltage of approximately −0.5 V.

The differential voltage VDIFF for the bus state Rec remains unchanged at 0.0 V.

The frame 450 of FIG. 2 can be used for communication on the bus 40 even when using the bus states L0_10BASE, L1_10BASE. Alternatively, any other frame format can be used.

In all other respects, the same applies as described with respect to the first embodiment example.

According to a third embodiment example, the communication control devices 11, 21 are set not to switch the bit rates in the frame 450 in CAN XL light Extended.

More specifically, the bit rate of the communication control devices 11, 21 is set to:

$$0 Mbit / s < arbitration bit rate t\_b1 = data bit rate t\_b2 <= 20 Mbit / s .$$

$$so that$$

$$bit time t\_bt1 = bit time t\_bt2$$

This saves additional surface area on the ASIC 26 of the responder, possibly also surface area on the ASIC 16 of the commander, if the subscriber station 100 does not otherwise require the bit rate switching function. Clock recovery from the CAN bit stream is facilitated as well, so that there is no need for a quartz oscillator in the responder. This makes it possible to further reduce the cost of the responder. Eliminating a quartz oscillator is also possible in the above-described embodiment examples.

Furthermore, not only the communication control devices 21, but also the communication control devices 11 can be configured to not carry out arbitration. The subscriber station 100 (commander) controls the communication in such a way that access conflicts on the bus 40 are avoided.

This, too, makes it possible to achieve a cost-efficient connection of responders to differential bus systems, in particular a CAN bus system or a 10BASE-T1S system.

In all other respects, the same applies as described with respect to the first embodiment example.

All of the above-described embodiments of the subscriber stations 100, 101 . . . 10N of the bus system 1, and of the method carried out therein can be used alone or in all possible combinations. It is in particular possible to combine all features of the above-described embodiment examples and/or modifications thereof as desired. Additionally or alternatively, in particular the following modifications are possible.

The bus system 1 according to the embodiment examples can in particular be a communication network in which data can be transmitted in series at two different bit rates. In the bus system 1, it must be ensured that exclusive, collision-free access of a subscriber station 100, 101 . . . 10N to a common channel is guaranteed at least for certain periods of time.

The number and arrangement of the subscriber stations 100, 101 . . . 10N in the bus system 1 of the embodiment examples is as needed. It is possible for there to be one or more of the subscriber stations 100 in the bus system 1. It is possible for there to be more than one subscriber station 100, to which at least one subscriber station 101 . . . 10N is assigned as described above, in the bus system 1.

It is possible that the module 15 is disposed separately from the communication control device 11 in the subscriber station 100. It is possible that the module 25 is disposed separately from the communication control device 21 in at least one of the subscriber stations 101 . . . 10N.

It is possible that the module 18 is disposed separately from the communication control device 11 in the subscriber station 100. It is possible that the module 28 is disposed separately from the communication control device 21 in at least one of the subscriber stations 101 . . . 10N.

It is possible that the module 19 is disposed separately from the transceiver 12 in the subscriber stations 100. It is possible that the module 29 is disposed separately from the transceiver 22 in at least one of the subscriber stations 101 . . . 10N.

What is claimed is:

1. A transceiver for a commander subscriber station or a responder subscriber station of a serial bus system, the transceiver comprising:
a transmitter module configured to send a digital transmission signal based on a frame for a message to be sent via a bus as a differential signal to the bus of the bus system;
a receiver module configured to receive a differential signal from the bus and to generate a digital reception signal from the differential signal received from the bus and to forward the digital reception signal to a communication control device for evaluating the digital reception signal using a predetermined frame for a message from the bus; and
an operating mode switching module configured to switch the transmitter module and the receiver module into a first operating mode between messages on the bus or to switch the transmitter module and the receiver module into a second or third operating mode for sending or receiving a message;
wherein the operating mode switching module is configured to switch the transmitter module and the receiver module from the first operating mode into the third operating mode for receiving a message from the bus when the operating mode switching module has received an edge from the bus.

2. The transceiver according to claim 1, wherein the operating mode switching module is configured to switch the transmitter module and the receiver module from the third operating mode into the first operating mode when the operating mode switching module has received a predetermined signal from the communication control device.

3. The transceiver according to claim 1, wherein:
the transceiver is configured to use a first physical layer in the first operating mode to generate only a first bus state on the bus, and
the transceiver is configured to use a second physical layer that differs from the first physical layer in the second and third operating mode to generate a second and third bus state as respective symmetrical bus states for the differential signals on the bus.

4. The transceiver according to claim 3, wherein the only first bus state for differential signals on the bus in the first operating mode differs from each of the symmetrical bus states for differential signals on the bus for which the transceiver is configured in the second and third operating modes.

5. The transceiver according to claim 1, wherein the transceiver is configured to switch on a predetermined reception threshold for generating a digital reception signal from the differential signal received from the bus when switching from the first operating mode to the third operating mode, and to switch off the predetermined reception threshold when switching from the third operating mode to the first operating mode.

6. A responder subscriber station for a serial bus system, comprising:
a communication control device configured to control communication between the subscriber station and a commander subscriber station of the bus system and to evaluate at least one signal received from a bus of the bus system using a predetermined frame for a message from the bus; and
a transceiver, including:
a transmitter module configured to send a digital transmission signal based on a frame for a message to be sent via the bus as a differential signal to the bus of the bus system,
a receiver module configured to receive a differential signal from the bus and to generate a digital reception signal from the differential signal received from the bus and to forward the digital reception signal to a communication control device for evaluating the digital reception signal using the predetermined frame for the message from the bus, and
an operating mode switching module configured to switch the transmitter module and the receiver module into a first operating mode between messages on the bus or to switch the transmitter module and the receiver module into a second or third operating mode for sending or receiving a message,
wherein the operating mode switching module is configured to switch the transmitter module and the receiver module from the first operating mode into the third operating mode for receiving a message from the bus when the operating mode switching module has received an edge from the bus;
wherein the communication control device is configured to signal the transceiver at each bit of the predetermined frame into which of the operating modes the transceiver is to be switched.

7. The responder subscriber station according to claim 6, wherein the communication control device is configured to send a message to the commander subscriber station via the bus only if the commander subscriber station has prompted the responder subscriber station to send the message to the commander station via a polling.

8. The responder subscriber station according to claim 6, further comprising
an operating mode signaling module configured to signal into which of three different operating modes the transceiver is to be switched;
wherein the operating mode signaling module is configured to signal a switchover of the operating mode at a beginning of the message in the transmission signal if the transceiver is to be switched to an operating mode for sending the message to the bus; and
wherein the operating mode signaling module is configured to signal a switchover of the operating mode at the beginning of the message if the transceiver is to be switched to an operating mode for receiving the message from the bus.

9. The responder subscriber station according to claim 6, wherein the responder subscriber station is configured to use a CAN XL frame in an XLFF format as the predetermined frame.

10. A commander subscriber station for a serial bus system, comprising:
a communication control device configured to control communication between the subscriber station and a responder subscriber station of the bus system and to evaluate at least one signal received from a bus of the bus system using a predetermined frame for a message from the bus; and
a transceiver, including:
a transmitter module configured to send a digital transmission signal based on a frame for a message to be sent via the bus as a differential signal to the bus of the bus system,
a receiver module configured to receive a differential signal from the bus and to generate a digital reception signal from the differential signal received from the bus and to forward the digital reception signal to a communication control device for evaluating the digital reception signal using the predetermined frame for the message from the bus, and
an operating mode switching module configured to switch the transmitter module and the receiver module into a first operating mode between messages on the bus or to switch the transmitter module and the receiver module into a second or third operating mode for sending or receiving a message,
wherein the operating mode switching module is configured to switch the transmitter module and the receiver module from the first operating mode into the third operating mode for receiving a message from the bus when the operating mode switching module has received an edge from the bus;
wherein the communication control device is configured to signal the transceiver at each bit of the predetermined frame into which of the first, second, and third operating modes the transceiver is to be switched.

11. The commander subscriber station according to claim 10, wherein the communication control device is configured to prompt the responder subscriber station to send a message to the commander subscriber station via the bus via a polling.

12. The commander subscriber station according to claim 10, further comprising:
an operating mode signaling module for signaling into which of three different operating modes the transceiver is to be switched;
wherein the operating mode signaling module is configured to signal a switchover of the operating mode at a beginning of the message in the transmission signal if the transceiver is to be switched to an operating mode for sending the message to the bus; and
wherein the operating mode signaling module is configured to signal a switchover of the operating mode at a beginning of the message if the transceiver is to be switched to an operating mode for receiving the message from the bus.

13. A bus system, comprising:
a bus;
at least two subscriber stations which are connected to one another via the bus such that they communicate in series with one another and of which one subscriber station is a commander subscriber station and at least one subscriber station is a responder subscriber station;
wherein the commander station includes:
a communication control device configured to control communication between the commander subscriber station and the responder subscriber station and to evaluate at least one signal received from the bus using a predetermined frame for a message from the bus, and
a transceiver, including:
a transmitter module configured to send a digital transmission signal based on a frame for a message to be sent via the bus as a differential signal to the bus of the bus system,
a receiver module configured to receive a differential signal from the bus and to generate a digital reception signal from the differential signal received from the bus and to forward the digital reception signal to a communication control device for evaluating the digital reception signal using the predetermined frame for the message from the bus, and
an operating mode switching module configured to switch the transmitter module and the receiver module into a first operating mode between messages on the bus or to switch the transmitter module and the receiver module into a second or third operating mode for sending or receiving a message,
wherein the operating mode switching module is configured to switch the transmitter module and the receiver module from the first operating mode into the third operating mode for receiving a message from the bus when the operating mode switching module has received an edge from the bus,
wherein the communication control device is configured to signal the transceiver at each bit of the predetermined frame into which of the first, second, and third operating modes the transceiver is to be switched; and
wherein the responder subscriber station includes:
a communication control device configured to control communication between the responder subscriber station and the commander subscriber station and to evaluate at least one signal received from the bus using a predetermined frame for a message from the bus, and
a transceiver, including:
a transmitter module configured to send a digital transmission signal based on a frame for a message to be sent via the bus as a differential signal to the bus of the bus system,
a receiver module configured to receive a differential signal from the bus and to generate a digital reception signal from the differential signal received from the bus and to forward the digital reception signal to a communication control device for evaluating the digital reception signal using the predetermined frame for the message from the bus, and
an operating mode switching module configured to switch the transmitter module and the receiver module into a first operating mode between messages on the bus or to switch the transmitter module and the receiver module into a second or third operating mode for sending or receiving a message,
wherein the operating mode switching module is configured to switch the transmitter module and the receiver module from the first operating mode into the third operating mode for receiving a message from the bus when the operating mode switching module has received an edge from the bus;
wherein the communication control device is configured to signal the transceiver at each bit of the predetermined frame into which of the operating modes the transceiver is to be switched.

14. A method for communication in a serial bus system, the method comprising:
communicating on a bus of system serial bus system using a commander subscriber station and a responder subscriber station;
wherein the commander subscriber station includes:
a communication control device configured to control communication between the commander subscriber station and the responder subscriber station and to evaluate at least one signal received from the bus using a predetermined frame for a message from the bus, and
a transceiver, including:
a transmitter module configured to send a digital transmission signal based on a frame for a message to be sent via the bus as a differential signal to the bus of the bus system,
a receiver module configured to receive a differential signal from the bus and to generate a digital reception signal from the differential signal received from the bus and to forward the digital reception signal to a communication control device for evaluating the digital reception signal using the predetermined frame for the message from the bus, and
an operating mode switching module configured to switch the transmitter module and the receiver module into a first operating mode between messages on the bus or to switch the transmitter module and the receiver module into a second or third operating mode for sending or receiving a message,
wherein the operating mode switching module is configured to switch the transmitter module and the receiver module from the first operating mode into the third operating mode for receiving a message from the bus when the operating mode switching module has received an edge from the bus,
wherein the communication control device is configured to signal the transceiver at each bit of the predetermined frame into which of the first, second, and third operating modes the transceiver is to be switched; and
wherein the responder subscriber station includes:
a communication control device configured to control communication between the responder subscriber station and the commander subscriber station and to evaluate at least one signal received from the bus using a predetermined frame for a message from the bus, and
a transceiver, including:
a transmitter module configured to send a digital transmission signal based on a frame for a message to be sent via the bus as a differential signal to the bus of the bus system,
a receiver module configured to receive a differential signal from the bus and to generate a digital reception signal from the differential signal received from the bus and to forward the digital reception signal to a communication control device for evaluating the digital reception signal using the predetermined frame for the message from the bus, and
an operating mode switching module configured to switch the transmitter module and the receiver module into a first operating mode between messages on the bus or to switch the transmitter module and the receiver module into a second or third operating mode for sending or receiving a message,
wherein the operating mode switching module is configured to switch the transmitter module and the receiver module from the first operating mode into the third operating mode for receiving a message from the bus when the operating mode switching module has received an edge from the bus;
wherein the communication control device is configured to signal the transceiver at each bit of the predetermined frame into which of the operating modes the transceiver is to be switched.

15. The method according to claim 14, wherein, in contrast to a CAN XL subscriber station,
the commander subscriber station and the responder subscriber station do not carry out bit monitoring when sending a message,
the commander subscriber station does not send an ACK bit when the commander subscriber station has correctly received a message,
the responder subscriber station does not send an ACK bit when the responder subscriber station has correctly received a message,
the commander subscriber station and the responder subscriber station do not carry out error signaling,
the commander subscriber station and the responder subscriber station do not use overload frames,
the commander subscriber station and the responder subscriber station do not carry out an automatic retransmission, and
the commander subscriber station and the responder subscriber station do not automatically shut down the responder subscriber station upon detection of a predetermined number of communication errors.
